(19) United States
(12) Patent Application Publication
(10) Pub. No.: US 2004/0230496 A1
(43) Pub. Date: Nov. 18, 2004

(54) Easy ordering system

(76) Inventors: Robert Michael Neuman, Santa Clarita, CA (US); Maria Griselda Neuman, Santa Clarita, CA (US)

Correspondence Address: Maria Neuman, 15556 Bronco Drive, Santa Clarita, CA, 91387, US

(21) Appl. No.: 10/814,996

(22) Filed: Mar. 31, 2004

Related U.S. Application Data
(60) Provisional application No. 60/459,639, filed on Apr. 3, 2003.

(51) Int. Cl. G06F 17/60

(52) U.S. Cl. 705/26

(57) ABSTRACT

A remote ordering process which allows a consumer to have stored in a handheld electronic device, all of the menu items or items for sale from a given restaurant or other retailer. Furthermore, the device and its software would have the ability to provide the consumer with a selection of the consumers frequently ordered meals or selections already stored and ready to be ordered or edited at will.

This enables the consumer to select and then transmit his/her order via infrared and/or any other means directly to the restaurant or retailer's receiving computer system, thus bypassing human error and making the transaction speedier. This process is designed specifically for but not limited to a drive-through scenario.

As part of this process, the consumer may also be able to pay for the transaction through the wireless transmission of the consumer's credit card and/or debit card information.

A remote ordering process which allows a consumer to have stored in a handheld electronic device, all of the menu items or items for sale from a given restaurant or other retailer. This enables the consumer to select and then transmit his/her order via infrared and/or any other means directly to the restaurant or retailer's receiving computer system, thus bypassing human error and making the transaction speedier. This process is designed specifically for but not limited to a drive-through scenario.

As part of this process, the consumer may also be able to pay for the transaction through the wireless transmission of the consumer's credit card and/or debit card information.

### BACKGROUND OF THE INVENTION

Problem:

Ordering food at a drive-through restaurant is a frustrating, hit or miss situation. After waiting in line behind other cars, the consumer must now speak out the order, item by item into a speaker phone to communicate with a person inside the restaurant taking the order. All special requests, such as “no onions” or “extra cheese” must be related to this person inside wearing headphones and taking the order. As is the case, many a time, what is said by the consumer, is not what is heard by the listening order taker, resulting in inaccurate or incomplete orders.

As is the nature of the drive-through, most consumers don't realize the deficiency in their order until they reach their final destination by which time it is too late to complain and instead just get angry and that particular retailer.

Solution:

The Easy Ordering System consists of a Remote Ordering Device and its Remote Ordering Software System and a Remote Ordering Point of Sale System with its Remote Order Receiving Software System. Optionally, an Internet or telephone based Menu Download Site may also be incorporated in the Remote Ordering process.

The Remote Ordering Device can be any general purpose portable computing devices, including any or all of the following; Personal Data Assistant (PDA), Cell Phone with embedded PDA, Laptop Computer, Notebook Computer or Pocket Computer. Or it may be in the form of a dedicated Remote Ordering Device, possibly distributed by retailers offering this service. The Remote Ordering Device should provide the following functions:

1. Allow the user to run the Remote Ordering software system.

2. Possibly allow for connection to the internet.

3. Permit a wireless data connection to the retailer's Point of Sale system either through infrared, optical, Radio Frequency or other means.

The Remote Ordering Software system consists of software packages that can be distributed to users of portable general purpose computing devices to install on their systems or that can be preloaded, possibly in ROM (Read Only Memory), on the dedicated Remote Ordering Devices that provides the following functionality:

1. Allow the current menu item selections, prices and any corresponding data (graphics, audio or text) to be downloaded from the internet or through other remote or local data connection to retailer's host computer system.

2. Allow the user to store the menu data files for future use.

3. Allow menu data files to be updated as necessary with current data.

4. Provide the user with an interface for compiling their order from the retailer's menu selections.

5. Allow the storage and retrieval of the customer's order for possible reuse.

6. Possibly give a total cost for the user's order.

7. Upload the user's order to the retailer's POS (Point of Sale) system.

### SUMMARY OF THE INVENTION

The Remote Ordering Point of Sale system is either a general purpose computing device or network of such devices, or is embedded in the Retailer's existing Point of Sale System, and provides the following capabilities:

1. Allow the retailer to run the Remote Order Receiving Software.

2. Permit a wireless data connection to the retailer's Point of Sale system either through infrared, optical, Radio Frequency or other means.

3. Possibly allow for connection to the internet.

The Remote Order Receiving Software system provides the following functionality to the retailer:

1. Allow the current menu item selections, prices and any corresponding data (graphics, audio or text) to be downloaded through a local data connection by the customers' Remote Ordering Devices.

2. In cases where the retailer's menu data file is already residing on a Remote Ordering Device, the device may be queried for the file's modification date to see if it is current and initiate the transfer of any necessary updates.

3. Offer the customer “up sell” items such as Biggie size portions or any other promotions.

4. Receive orders uploaded by the customers' Remote Ordering Devices and enter them into the retailer's POS (Point of Sale) system and into their order processing queue.

5. Transmit confirmation that the order has been received to the Remote Ordering Device, possibly providing a total cost.

6. Optionally, provide current menu data files to the Menu Download Site.

The Menu Download Site is a possible addition to the Remote Ordering System that allows customers to download a retailer's menu data files from an offsite location so that they may compile their orders prior to visiting the retailer. This downloading may be accomplished through an internet connection or other telephonic or data communications channels.

### Use Scenarios

1. First Time User A

A person who owns a pda (or other hand held device capable of wireless transmission) goes to their computer and logs onto a particular restaurant's website. From this website, First Time User A sees that they can download onto their device the entire menu, including pricing. First Time User A now proceeds to follow the instructions on the website to do this and within seconds has this restaurant's entire menu on their handheld device.

Now if First Time User A chooses to, they can go to another company's website and repeat the procedure. By doing this, they can have the menu's of several restaurants literally at their finger tips. (FIG. 1B)

They can now click on any one of these files to open it. They will see the menu displayed before them. They can now select their favorite typical menus for faster service at this particular restaurant. For instance, let's say that they always order an EggMcMuffin™ Meal with a Diet Coke™ instead of a coffee. They can now create a file called, say, “Breakfast” that includes an EggMcMuffin™ Meal with a Diet Coke™ instead of a coffee.

For lunch at this restaurant they usually bring their kids and get: a Big Mac™ Meal with a Diet Coke™, supersized; a hamburger happy meal, no pickles, with a Coke™; a Two Cheeseburger™ Meal, no onions, with an iced tea; and a Crispy Chicken™ Meal, totally plain, with a Coke™. They now go through the menu and create this “Lunch” menu. Following the same procedure, they create a “Dinner” menu also.

Now they can click open another restaurant's menu and do the exact same thing, create customized menus to save as files for each restaurant that they frequent. From now on, when First Time User A goes to one of these places, life will be a lot easier. They can just click on the icon of the restaurant of their choice, select from one of their pre-saved menu files (FIG. 1E), or create a new one to adapt to any circumstance (FIG. 1F).

2. First Time User B

A person who owns a pda (or other hand held device capable of wireless transmission) goes to the restaurant of their choice. At the restaurant, there is a station for people with handheld devices to use to down load the restaurant's entire menu, including pricing. All First Time User B needs to do is follow some directions and point their pda or other hand held device at the restaurant's transmitter/receiver. Within seconds First Time User B has this restaurant's entire menu on her hand held device.

Now if First Time User B chooses to, they can go to another company's store and repeat the procedure. By doing this, she can have the menu's of several restaurants literally at her finger tips. (FIG. 1)

They can now click on any one of these files to open it. They will see the menu displayed before them. They can now select their favorite typical menus for faster service at this particular restaurant. For instance, let's say that they always order an EggMcMuffin™ Meal with a Diet Coke™ instead of a coffee. They can now create a file called, say, “Breakfast” that includes an EggMcMuffin™ Meal with a Diet Coke™ instead of a coffee.

For lunch at this restaurant they usually bring their kids and get: a Big Mac™ Meal with a Diet Coke™, supersized; a hamburger happy meal, no pickles, with a Coke™; a Two Cheeseburger™ Meal, no onions, with an iced tea; and a Crispy Chicken™ Meal, totally plain, with a Coke™. They now go through the menu and create this “Lunch” menu. Following the same procedure, they create a “Dinner” menu also. Now they can click open another restaurant's menu and do the exact same thing, create customized menus to save as files for each restaurant that they frequent.

From now on, when First Time User B goes to one of these places, life will be a lot easier. They can just click on the icon of the restaurant of their choice, select from one of their pre-saved menu files, or create a new one to adapt to any circumstance.

3. First Time User C

A person who does not own a pda (or other hand held device capable of wireless transmission) goes to their favorite restaurant and finds that the restaurant is selling (or maybe giving away as part of a promotion) a cool handheld transmitting device that has this restaurant's menu already downloaded on to it. The device could be capable of some other functions as well; calculator, calendar, clock, etc. (FIG. 2)

They get very happy, this will make ordering easier. They can now click on the company's logo and see the menu displayed before them. At this point they can select their favorite typical menus for faster service at this particular restaurant. For instance, let's say that they always order an EggMcMuffin™ Meal with a Diet Coke™ instead of a coffee. They can now create a file called, say, “Breakfast” that includes an EggMcMuffin™ Meal with a Diet Coke™ instead of a coffee. For lunch at this restaurant they usually bring their kids and get: a Big Mac™ Meal with a Diet Coke™, supersized; a Hamburger Happy Meal™, no pickles, with a Coke™; a Two Cheeseburger™ Meal, no onions, with an iced tea; and a Crispy Chicken™ Meal, totally plain, with a Coke™. They now go through the menu and create this “Lunch” menu. Following the same procedure, they create a “Dinner” menu also.

Whenever First Time User C wants to order from now on, they can just select from one of their pre-saved menu files, or create a new one to adapt to any circumstance.

4. Parent with Children in Car

The Way It is Now:

A mother with several picky eaters for children drives up to a fast food restaurant drive-through and gets in line behind other waiting cars in the queue. While waiting in line, she rehearses the order in her mind to make sure she's got it right.

Now it is her turn at the ordering station. She says, “Hi, I'd like a Hamburger Happy Meal™ with no pickles, a Coke™ with that please; a number 7, Crispy Chicken™ Meal, plain, nothing on it, just the chicken and buns, a Coke™ with that one: and a number 2, Two Cheeseburger™ Meal, also with no pickles and no lettuce, and an iced tea with that one, thanks.” Now comes the stressful part where the person on the other end of the speakerphone repeats the order as they heard it. This is usually done in some other order, like the drinks bunched together, so that the mother agrees to whatever is said without really being sure that it is correct just to move along. She now moves forward to the pick-up window, pays whatever they tell her to, receives the food and drives away. The order might be correct, but a great many times it is not.

The Way It will be with the Easy Ordering System:

A mother with several picky eaters for children drives up to a fast food restaurant drive-through and gets in line behind other waiting cars in the queue. She reaches for her handheld device, her half of the Easy Ordering System which has this restaurant's menu already downloaded into it. She turns the device on and selects the Easy Ordering System (eos) on the main screen (FIG. 1A). Now she can select the restaurant of her choice (FIG. 1B). From this screen she can select either a pre-saved file containing an order or create a new file with a different order (FIG. 1E). She chooses the one that her kids always order at this particular restaurant for lunch.

Now it is her turn at the ordering station. She says, “Hi, I'll transfer my order and payment info”, and with a click, she makes a wireless transfer to the receiver that the restaurant has. The order is now safely in the restaurant's computer, being displayed in the kitchen to be prepared and is also displayed at the check-out window. The queue can now move forward since she is not taking up valuable time saying her order and having repeated back to her. She is able to move up to the pick-up window and get her order and receipt. This makes the mother happy and she thinks of coming back to this drive-through soon.

5. Parent with Children and Visitor in Car

The Way It is Now:

A mother with several picky eaters for children has her mother-in-law visiting for a few days and decides to drive up to a fast food restaurant drive-through and get in line behind other waiting cars in the queue. While waiting in line, she not only has to rehearse her children's order, but must now also add in something for herself and her mother-in-law. She does this all in her head while making small talk, its tough.

Now it is her turn at the ordering station. She says, “Hi, I'd like a Hamburger Happy Meal™ with no pickles, a Coke™ with that please; a number 7, Crispy Chicken™ Meal, plain, nothing on it, just the chicken and buns, a Coke™ with that one: and a number 2, a Two Cheeseburger™ Meal, also with no pickles and no lettuce, and an iced tea with that one. Also, a Double Cheeseburger™ Meal, with no ketchup or onions, a Diet Coke™ with that, and another Double Cheeseburger™ Meal, with everything, also with a Diet Coke™, thanks.”

Now again comes the stressful part where the person on the other end of the speakerphone repeats the order as they heard it. This is usually done in some other order, like the drinks bunched together, so that the mother agrees to whatever is said without really being sure that it is correct just to move along. She now moves forward to the pick-up window, pays whatever they tell her to, receives the food and drives away. The order might be correct, but a great many times it is not.

The Way It will be with the Easy Ordering System:

A mother with several picky eaters for children has her mother-in-law visiting for a few days and decides to drive up to a fast food restaurant drive-through and get in line behind other waiting cars in the queue. She reaches for her handheld device, her half of the Easy Ordering System which has this restaurant's menu already downloaded into it. She turns the device on (FIG. 1), selects her pre-saved order, the one that her kids always order at this particular restaurant for lunch. She now adds two Double Cheeseburger™ Meals, one with no ketchup or onions and both with Diet Cokes™ to her file to be transferred.

Now it is her turn at the ordering station. She says, “Hi, I'll transfer my order”, and with a click, she makes a wireless transfer to the receiver that the restaurant has. The order is now safely in the restaurant's computer, being displayed in the kitchen to be prepared and is also displayed at the check-out window. The queue can now move forward since she is not taking up valuable time saying her order and having it repeated back to her. This makes the mother happy and she thinks of coming back to this drive-through soon.

6. Office Worker

The Way It is Now:

A nice office worker decides to have fast food for lunch. Being such a nice person, he asks his fellow officemates if anyone would like anything from that particular restaurant. He is suddenly besieged by cubical dwellers who would love to get “this or that”, and “please hold the mustard” or “add onions to that”. He soon realizes that he needs to writes all of this down and does so. He leaves his office in a less “nice” mood, gets into the queue behind the other cars at the drive-through, and when it is his turn proceeds to read off the long list into the speaker phone.

Meanwhile, the people in the cars behind him begin to get angry at the guy taking so long up ahead. He finally finishes placing the order, accepts whatever read back the order-taker gave him, just to get out of there and moves forward. As he moves forward he realizes what a nightmare it is going to be to get everyone to pay him back correctly when he gets back to the office on top of this disaster. He now collects the food, (which may or may not be correct), at the window and heads back to his office promising himself to never offer to run for fast food again!

The Way It will be with the Easy Ordering System:

A nice office worker decides to have fast food for lunch. Being such a nice person, he asks his fellow officemates if anyone would like anything from that particular restaurant. He is suddenly besieged by cubical dwellers who would love to get “this or that”, and “please hold the mustard” or “add onions to that”. He takes out his pda (or other hand held device) and selects the Easy Ordering System (eos) on the main screen (FIG. 1A). Now he can select the restaurant of his choice (FIG. 1B). From this screen he can select either a pre-saved file containing an order or create a new file with a different order (FIG. 1E). He now creates a file containing the exact order, with all of their specifications, such as drinks, super-size, extra onions, etc . . . He leaves his office and gets into the queue behind the other cars at the drive-through.

When it is his turn, he says “Hi, I'm going to transfer this order, thanks.” He then aims his device at the restaurant's receiver and clicks, beaming the entire order. Instantly, the entire office's order is now on the kitchen computer and is being prepared. He moves forward almost as quickly as he got there! He now collects the food at the window and heads back to his office thinking about what nice people he works with.

Back at the office, he once again takes out his pda and gives each person their correct subtotal which they happily pay since they got the right meal.

7. Parent with Children Ordering inside a Restaurant

The Way It is Now:

A mother with several picky eaters for children goes into a fast food restaurant and gets in line behind other waiting customers. While waiting in line, she rehearses the order in her mind to make sure she's got it right.

Now it is her turn at the ordering station. She says, “Hi, I'd like a Hamburger Happy Meal™ with no pickles, a Coke™ with that please; a number 7, Crispy Chicken™ Meal, plain, nothing on it, just the chicken and buns, a Coke™ with that one: and a number 2, a Two Cheeseburger™ Meal, also with no pickles and no lettuce, and an iced tea with that one, thanks.” Now comes the stressful part where the order taker repeats the order as they heard it. This is usually done in some other order, like the drinks bunched together, so that the mother agrees to whatever is said without really being sure that it is correct just to move along and get her kids seated as soon as possible. She now pays whatever they tell her to, receives the food and sits down.

The order might be correct, but a great many times it is not. If it is correct, she and her kids eat and leave happily, if a miscommunication occurred, she might have to make the choice of accepting it begrudgingly, or leaving her kids alone for a few minutes to correct the problem up at the counter and then finally sit down to eat in not too great a mood.

The Way It will be with the Easy Ordering System:

A mother with several picky eaters for children goes into a fast food restaurant and gets in line behind other waiting customers. She takes out her handheld Remote Ordering Device from her purse. She turns it on and selects the Easy Ordering System (eos) on the main screen (FIG. 1A). Now they can select the restaurant of their choice (FIG. 1B). From this screen she can select either a pre-saved file containing an order or create a new file with a different order (FIG. 1E). Now she selects the file that contains the order that she and her kids usually eat at this place for lunch (FIG. 1H). She now selects this file (FIG. 1I), reviews it (FIG. 1J), and can decide whether or not to make any changes to it by using the edit feature (FIG. 1K). She decides to use it as is.

It is now her turn at the ordering station. She says, “Hi, I can just transfer the order to you.” The customer service person at the register says gladly, “Oh sure, go right ahead.” The mother aims her Remote Ordering Device at the register's receiver and beams her order (FIG. 1L) instantly; the correct order has been transmitted and received. The kitchen can now start cooking the mother's order, and the mother's total is already displayed on both the register and the Remoter Ordering Device screen.

The mother pays, and steps out of line much faster while waiting for her food, allowing the next customer to be served. Now, barring gross incompetence in the kitchen (since they received her order directly), she receives her correct order. The mother can now sit down and enjoy a delightful meal with her children.

8. Mute People

By virtue of the fact that mute people cannot speak, they cannot use speakerphones to place a food and/or any other order. The Remote Ordering Device would finally allow mute people the freedom to drive-through and order just like everyone else.

A mute person would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

9. Deaf People

By virtue of the fact that deaf people cannot hear, they may not want to use speakerphones to place a food and/or any other order. It is probably very stressful to think that someone might be speaking to you, but you cannot hear them. Also, they cannot be sure that they are being heard, as the order-taker is not always ready for the next customer. The Remote Ordering Device would finally allow deaf people the freedom to drive-through and order just like everyone else.

A deaf person would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

10. Speech Impaired People

Drive-through's make the driver of the car speak out to a speakerphone, in outdoor traffic, and noisy conditions. Inevitably, miscommunications occur. Besides the embarrassment to the customer, this situation also costs the restaurant valuable drive-through queue time. This in turn not only frustrates other customers that are waiting, but can be a financial setback at an otherwise profitable time. People with speech impediments probably shy away from situations that make it even harder to be understood. The Remote Ordering Device would finally allow speech impaired people the freedom to drive-through and order just like everyone else.

A speech impaired person would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

11. Shy, Low Speaking People

Drive-through's make the driver of the car speak out to a speakerphone, in outdoor traffic, and noisy conditions. Inevitably, miscommunications occur. Even in the best of circumstances, it is a slightly stressful situation. Sometimes, quite a bit of back and forth conversation must go on between the order giver and the order taker before the order is settled upon. Besides the embarrassment to the customer, this situation also costs the restaurant valuable drive-through queue time. This in turn not only frustrates other customers that are waiting, but can be a financial setback at an otherwise profitable time. People who are shy or speak in a low, quiet fashion probably shy away from situations that make it even harder to be understood. The Remote Ordering Device would finally allow these people the freedom to drive-through and order just like everyone else. Shy, low speaking people would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

12. Customers with Heavy Accents

Drive-through's make the driver of the car speak out to a speakerphone, in outdoor traffic, and noisy conditions. Inevitably, miscommunications occur. Besides the embarrassment to the customer, this situation also costs the restaurant valuable drive-through queue time. This in turn not only frustrates other customers that are waiting, but can be a financial setback at an otherwise profitable time. People with heavy accents probably shy away from situations that make it even harder to be understood. The Remote Ordering Device would finally allow people with heavy accents the freedom to drive-through and order just like everyone else.

A person with a heavy accent would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

13. Restaurant Employee's with Heavy Accents

Drive-through's make the driver of the car speak out to a speakerphone, in outdoor traffic, and noisy conditions. Inevitably, miscommunications occur. Besides the embarrassment to the restaurant employee and to the customer who cannot understand them, this situation also costs the restaurant valuable drive-through queue time. This in turn not only frustrates other customers that are waiting, but can be a financial setback at an otherwise profitable time. The Remote Ordering Device would bypass miscommunication with the order taker who might have a heavy accent.

A person would just get into a queue of cars at a drive-through, turn on the Remote Ordering Device and select the Remote Ordering System (ros) on the main screen (FIG. 1A). Now they can select the restaurant of their choice (FIG. 1B). From this screen they can select either a pre-saved file containing an order or create a new file with a different order (FIG. 1E). When it is their car's turn near the receiver they can transmit the file, receive confirmation that their file was received including a total, continue to the delivery window and pay and receive their food.

14. Non-English Speakers at a Drive-through

Someone who does not have a command of the English language is very unlikely to use a drive-through to order food or anything else. The Remote Ordering Device would finally allow non-English speakers the freedom to drive-through and order just like everyone else. The menus displayed by a person's pda or other handheld device could be in any number of languages. In this manner, a person could select the products of their choosing in the language of their choosing. The file is still sent to an American receiving unit in English, but without the person having had to know any English.

A non-English speaker would follow the same routine as anyone else to use this system. It is as follows: they would get into a queue of cars at a drive-through, turn on the Remote Ordering Device and select the Easy Ordering System (eos) on the main screen (FIG. 1A). Now they can select the restaurant of their choice (FIG. 1B). From this screen they can select either a pre-saved file containing an order or create a new file with a different order (FIG. 1E), when it is their car's turn near the receiver they can transmit the file, receive confirmation that their file was received including a total, continue to the delivery window and pay and receive their food. All of these displays can be in the language of their choosing.

15. Non-English Speakers at the Point of Sale

Someone who does not have a command of the English language is very uncomfortable placing orders for food or anything else. They have to rely on the pictures of the food and just forget about customizing their order altogether. This can be both embarrassing and frustrating.

The Remote Ordering Device would finally allow non-English speakers the freedom to place an order just like everyone else. The menus displayed by a persons pda or other handheld device could be in any number of languages. In this manner, a person could select the products of their choosing in the language of their choosing. The file is still sent to an American receiving unit in English, but without the person having had to know any English.

The non-English speaker would go into a fast food restaurant and get in line behind other waiting customers. They would take out their handheld Remote Ordering Device. They would turn it on and select the Easy Ordering System (eos) on the main screen (FIG. 1A). Now they can select the restaurant of their choice (FIG. 1B). From this screen they can select either a pre-saved file containing an order or create a new file with a different order (FIG. 1E).

When it is their turn at the ordering station they can aim their Remote Ordering Device at the register's receiver and instantly, the correct order has been transmitted and received. The kitchen can now start cooking the order. The non-English speaker can also view the total being displayed on both the register and the Remoter Ordering Device screen.

16. Family at a Busy, Popular Restaurant I

The Way It is Now:

A family arrives at a busy, popular restaurant. The father checks in and tells the maitre'd that he has a party of five. He is told that the wait is about 35 minutes and is given a buzzer that will go off when a table is ready for them.

The family tries to keep themselves entertained until they get buzzed. They get seated; look over the menu while they place their drink order. When their drinks come, they are finally ready to place their food order. Now the waiter takes the order to the kitchen and has it prepared. Approximately sixty-five minutes after they arrived at the restaurant, they finally get their food and begin eating.

The Way It will be with the Easy Ordering System:

A family arrives at a busy, popular restaurant. The father checks in and tells the maitre'd that he has a party of five. He is told that the wait is about 35 minutes and is given a buzzer that will go off when a table is ready for them. He is also given a menu and a Remote Ordering System handheld device.

He and his family look over the menu, create a file containing their order and then the father walks over to a station in the waiting area provided for him to transfer his family's order straight to the kitchen.

At about thirty five minutes after arriving, the family's buzzer goes off and they get seated. The waiter comes over with their drinks, as they ordered and within just a few minutes, their entire meal is set out before them.

The whole dining experience made the family happy and since they were able to eat and leave sooner, the restaurant is also happy because it can seat more people during its busy dinner rush.

17. Family at a Busy, Popular Restaurant II

The Way It is Now:

A family arrives at a busy, popular restaurant. The father checks in and tells the maitre'd that he has a party of five. He is told that the wait is about 35 minutes and is given a buzzer that will go off when a table is ready for them.

The family tries to keep themselves entertained until they get buzzed. They get seated; look over the menu while they place their drink order. When their drinks come, they are finally ready to place their food order. Now the waiter takes the order to the kitchen and has it prepared. Approximately sixty-five minutes after they arrived at the restaurant, they finally get their food and begin eating.

The Way It will be with the Remote Ordering System:

A family arrives at a busy, popular restaurant. The father checks in and tells the maitre'd that he has a party of five. He is told that the wait is about 35 minutes and is given a buzzer that will go off when a table is ready for them. He is also given a menu and a Remote Ordering System handheld device.

He and his family look over the menu, create a file containing their order. Once they are seated, the father immediately beams the family's order straight to the kitchen by pointing the device to a receiver set up on the table. This helps the family avoid the often long wait for a waiter to stop by to take their order and in turn, helps the restaurant by freeing up the waiter's from having to take the initial orders.

In this manner, the waiter comes over with their drinks, as they ordered and within just a few minutes, their entire meal is set out before them.

The whole dining experience made the family happy and since they were able to eat and leave sooner, the restaurant is also happy because it can seat more people during its busy dinner rush.

### DESCRIPTION OF FIGURES

FIG. 1A Example of what the PDA screen could look like when selecting the software that could be run to accomplish the portable computing device portion of this invention.

FIG. 1B Example of what the PDA screen could look like after selecting Easy Ordering System (eos). This screen shows a variety of restaurant logos. It could be like this or be the logos for any retailers.

FIG. 1C Example of what the PDA screen could look like at the previous screen, 1B, if the user were to select the menu option along the bottom bar. This menu option gives the user several choices on our example such as: add menu, delete menu, about ros and exit.

FIG. 1D Example of what the PDA screen could look like at the previous screen 1B, if the user were to select the McDonald's logo.

FIG. 1E Example of what the PDA screen could look like after selecting McDonald's. The screen shows the user's favorite saved meals at McDonald's.

FIG. 1F Example of what the PDA screen could look like if the user selects the edit option along the bottom bar.

FIG. 1G Example of what the PDA screen could look like if the user selects the recent orders option along the bottom bar.

FIG. 1H Example of what the PDA screen could look like if the use highlights the lunch with kids saved meal file.

FIG. 1I Example of what the PDA screen could look like if the user clicks on the select button, thus choosing the lunch with kids file.

FIG. 1J Example of what the PDA screen could look like after FIG. 1I. It is an example of a saved menu showing a typical meal called lunch with kids.

FIG. 1K Example of what the PDA screen could look like if the edit feature is selected on the lunch with kids screen. It shows some editing possibilities such as delete, add, and modify.

FIG. 1L Example of what the PDA screen could look like when user is ready to transmit the order and selects the beam button along the bottom bar. Upon clicking this button, the order is safely transferred to the receiving station.

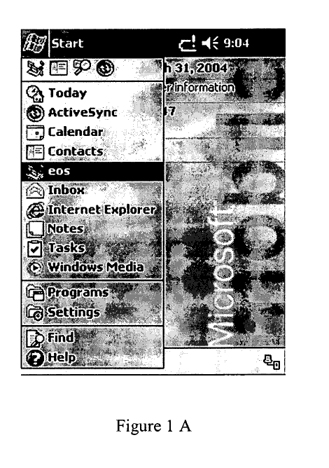

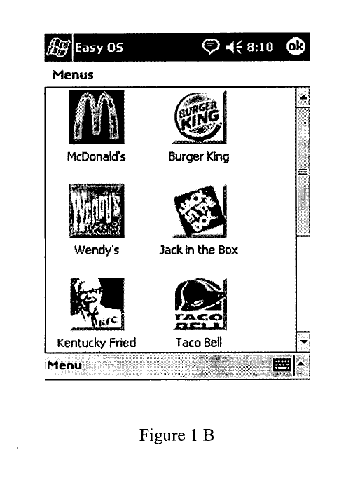

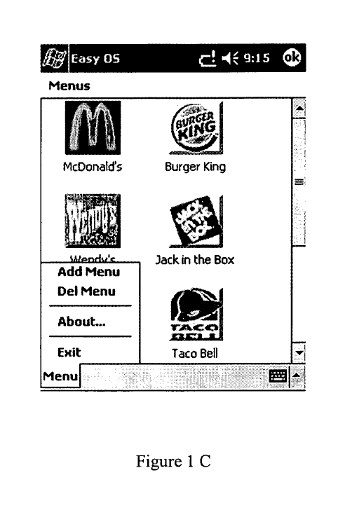

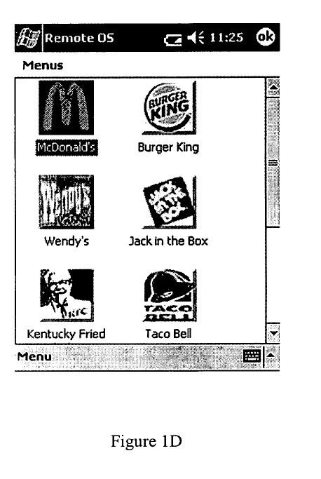

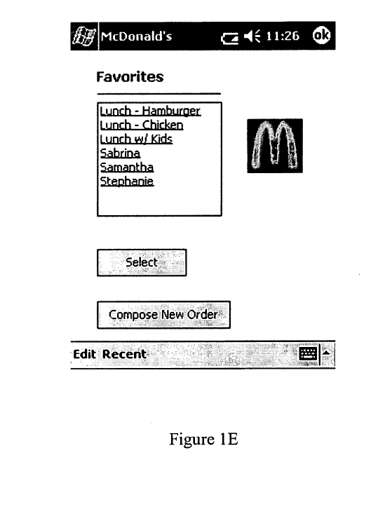

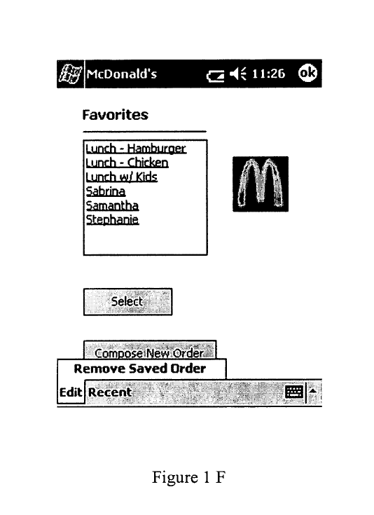

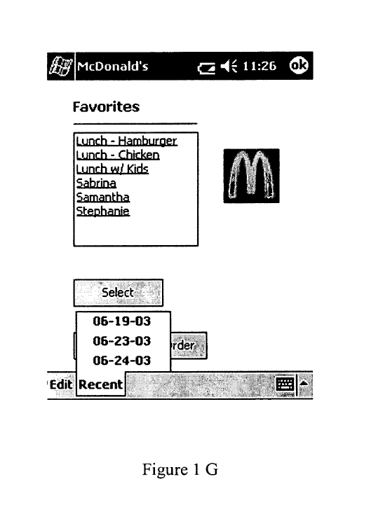

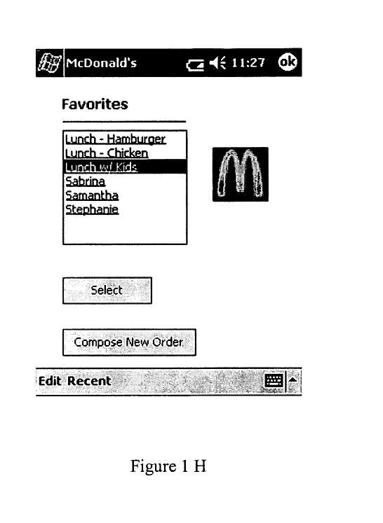

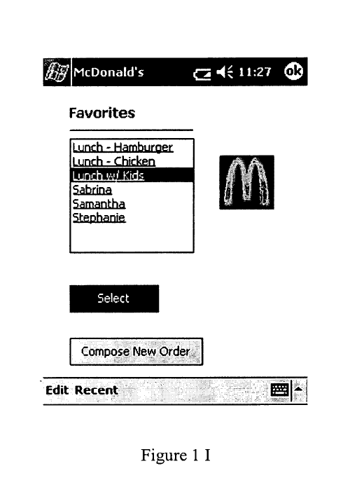

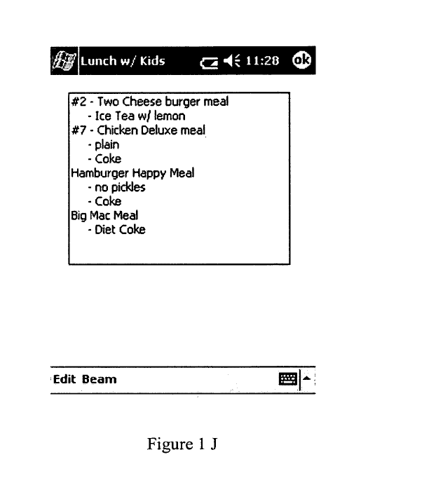

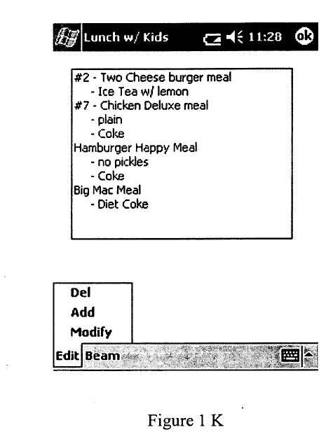

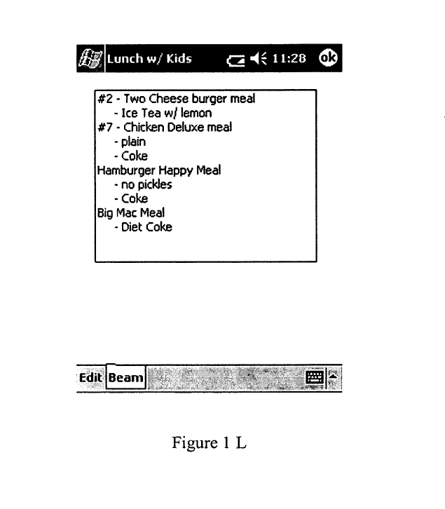

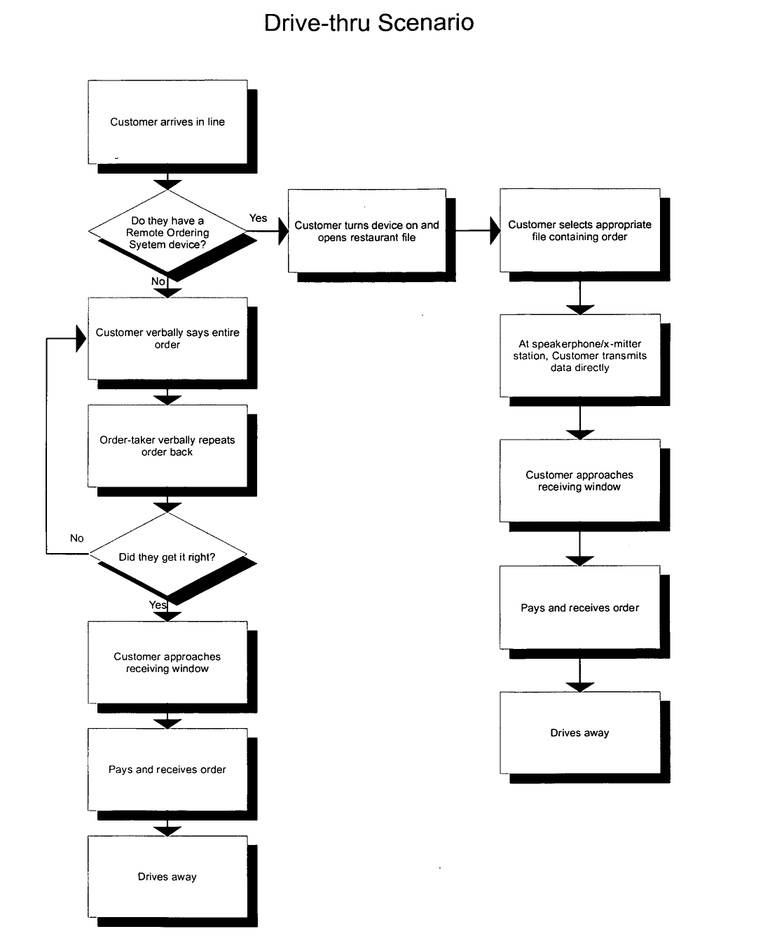

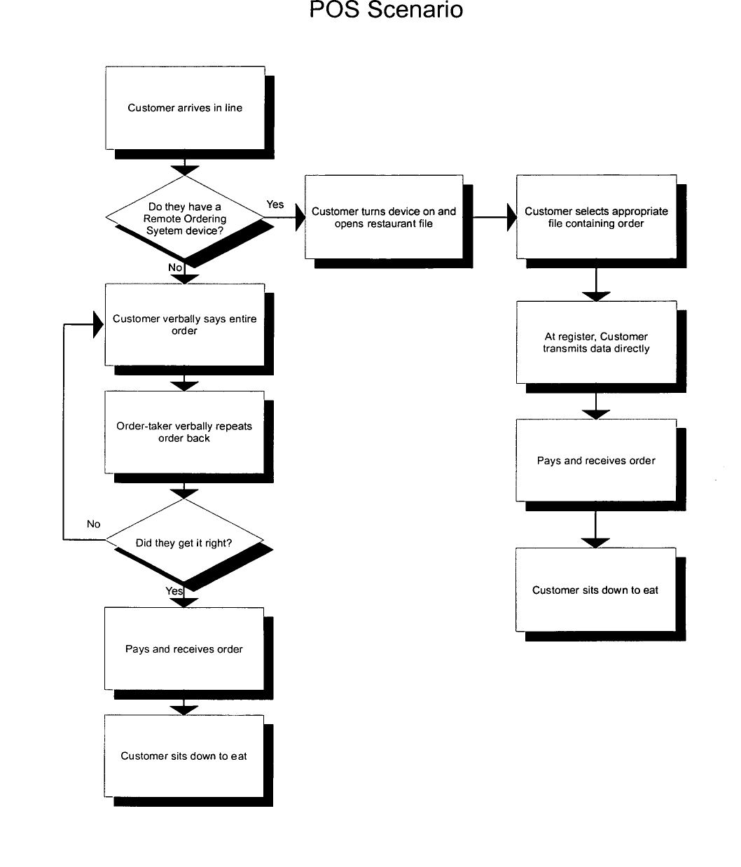

### DESCRIPTION OF DIAGRAMS

Diagram 1 Drive-thru Scenario. This is a flow chart which maps out the flow of the process by which a user can order a product at a drive-thru.

Diagram 2 POS Scenario. This is a flow chart which maps out the flow of the process by which a user can order a product at a Point of Sale, such as inside a fast food restaurant.

1. A remote ordering apparatus consisting of: a portable computing device having, a power source, a data entry portion, memory, a processor, a wireless data communications subsystem capable of transmitting and receiving digital data either through infrared, optical, Radio Frequency or other means.

2. A remote ordering apparatus as in claim 1 wherein, the portable computing device comprises a cell phone and a cell phone network.

3. A remote ordering apparatus as in claim 1 wherein, the portable computing device comprises a Personal Data Assistant (PDA).

4. A remote ordering apparatus as in claim 1 wherein, the portable computing device comprises a Cell phone with embedded PDA.

5. A remote ordering apparatus as in claim 1 wherein, the portable computing device comprises a Laptop Computer.

6. A remote ordering apparatus as in claim 1 wherein, the portable computing device comprises a Notebook Computer.

7. A remote ordering apparatus as in claim 1 wherein, the portable computing device comprises a Pocket Computer.

8. A remote ordering apparatus as in claim 1 wherein, the portable computing device comprises any general purpose portable computing device.

9. A remote ordering apparatus as in claim 1 wherein, the portable computing device comprises of any electronic apparatus built and dedicated as a remote ordering device solely for this purpose.

10. A receiving apparatus consisting of: a wireless data communications subsystem capable of transmitting and receiving digital data either through infrared, optical, Radio Frequency, or any other wireless means.

11. A fixed receiving apparatus as in claim 10 wherein, the fixed computing device is placed at a restaurant or retailer's drive-through ordering station.

12. A fixed receiving apparatus as in claim 10 wherein, the fixed computing device is placed at a restaurant or retailer's Point of Sale (POS) ordering station.

13. A fixed receiving apparatus as in claim 10 wherein, the fixed computing device is an input/output device for the main computer at the restaurant or retailer's establishment.

14. A receiving apparatus consisting of: a main data communications subsystem capable of transmitting and receiving digital data either through infrared, optical, Radio Frequency, or any other wireless means or hard wired means.

15. A fixed receiving apparatus as in claim 14 wherein, the fixed computing device is placed at a restaurant or retailer's establishment.

16. A fixed receiving apparatus as in claim 14 wherein, the fixed computing device receives data from the receiving apparatus in claim 10.

17. A fixed receiving apparatus as in claim 14 wherein, the fixed computing device can transmit updates in pricing, products, sales, etc, to the receiving apparatus claim 10 which would then transmit these changes to the portable computing device in claim 1.

18. A method for remotely ordering items consisting of: (a) driving a vehicle up to a restaurant or other retailer's drive-through and getting in the queue, (b) turning on one's remote ordering device, (c) selecting the software program necessary (in our Figures and examples, the software is called Easy Ordering System or EOS), (c) choosing the restaurant or retailer of choice by selecting it on one's device, (d) picking either a pre-saved file containing a favorite meal or choosing to compose a new order from a menu that has been previously downloaded into the memory of said remote ordering device, (e) upon reaching the ordering station at the drive-through, one may aim the device at the ordering station and beam or transmit the order, (f) proceed to pick-up window with your correct change out, since the remote ordering device tells you how your order will cost, (g) pay at the window and receive your correct order.

19. A method for remotely ordering items as in claim 18 with the further step of: transmitting wireless payment, whether by credit card, debit card or other financial conveyance, from the remote ordering device to the data receiving station.

20. A method for remotely ordering items as in claim 18 with the further step of: transmitting the credit card information received from the data receiving station over a communications link to a credit card authorization center for approval.

21. A method for remotely ordering items as in claim 18 with the further step of: receiving customer identity information data from the portable computing device.

22. A method for remotely ordering items consisting of: (a) walking up to a Point of Sale (POS) at a restaurant or other retailer and getting in the queue, (b) turning on one's remote ordering device, (c) selecting the software program necessary (in our Figures and examples, the software is called Easy Ordering System or EOS), (c) choosing the restaurant or retailer of choice by selecting it on one's device, (d) picking either a pre-saved file containing a favorite meal or choosing to compose a new order from a menu that has been previously downloaded into the memory of said remote ordering device, (e) upon reaching the ordering station (usually the cash register at a fast food restaurant), one may aim the device at the ordering station and beam or transmit the order, (f) proceed to pay and (g) receive your order.

23. A method for remotely ordering items as in claim 22 with the further step of: transmitting credit card information from the portable computing device to the data receiving station.

24. A method for remotely ordering items as in claim 22 with the further step of: transmitting the credit card information received from the data receiving station over a communications link to a credit card authorization center for approval.

25. A method for remotely ordering items as in claim 22 with the further step of: receiving customer identity information data from the portable computing device.
